(19) United States
(12) Patent Application Publication
(10) Pub. No.: US 2018/0121892 A1
(43) Pub. Date: May 3, 2018

(54) Automated Payments using a Cryptocurrency Address Embedded in a Passive Radio-Frequency Identification (RFID) Device

(71) Applicant: International Business Machines Corporation, Armonk, NY (US)

(72) Inventors: Saurabh Dwivedi, Delhi (IN); Himanshu Parashar, Rajasthan (IN); Rahul Parashar, Bangalore (IN)

(21) Appl. No.: 15/342,243

(22) Filed: Nov. 3, 2016

(51) Int. Cl. G06Q 20/06; G06Q 20/34

(52) U.S. Cl. CPC G06Q 20/065; G06Q 2220/00; G06Q 20/341

(57) ABSTRACT

A mechanism is provided for automatically making payments using a cryptocurrency address embedded in a passive radio-frequency identification (RFID) device. Responsive to receiving an indication, from a first user, of a payment to be made to a second user, cryptocurrency information is retrieved from a second user device associated with the second user. Responsive to receiving the cryptocurrency information, a payment transaction is generated with a cryptocurrency service provider via a network. A status response is received from the cryptocurrency service provider indicating a status of a transfer of an indicated amount of cryptocurrency from a cryptocurrency address of the first user to a cryptocurrency address of the second user completing. Based on the status response, an indication is provided to the first user that the payment transaction has completed.

### BACKGROUND

The present application relates generally to an improved data processing apparatus and method and more specifically to mechanisms for automatically making payments using a cryptocurrency address embedded in a passive radio-frequency identification (RFID) device.

Cryptocurrency is a medium of exchange like normal currencies such as the United States dollar (USD), but designed for the purpose of exchanging digital information through a process made possible by certain principles of cryptography. Cryptography is used to secure the transactions and to control the creation of new coins. The first cryptocurrency to be created was Bitcoin back in 2009. Today there are hundreds of other cryptocurrencies, often referred to as Altcoins, such as Litecoin, Peercoin, Primecoin, Namecoin, Ripple, Quark, Dash, Blackcoin, etc. Put another way, cryptocurrency is electricity converted into lines of code with monetary value. In the simplest of forms, cryptocurrency is digital currency.

Unlike centralized banking, like the Federal Reserve System, where governments control the value of a currency like USD through the process of printing fiat money, government has no control over cryptocurrencies as they are fully decentralized. Most cryptocurrencies are designed to decrease in production over time like Bitcoin, which creates a market cap on them. That's different from fiat currencies where financial institutions can always create more, hence inflation. Bitcoin will never have more than 21 million coins in circulation. The technical system on which all cryptocurrencies are based on was created by Satoshi Nakamoto.

While hundreds of different cryptocurrency specifications exist, most are derived from one of two protocols: Proof-of-work or Proof-of-stake. All cryptocurrencies are maintained by a community of cryptocurrency miners who are members of the general public that have set up their computers or application-specific integrated circuit (ASIC) machines to participate in the validation and processing of transactions.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for automatically making payments using a cryptocurrency address embedded in a passive radio-frequency identification (RFID) device. The illustrative embodiment retrieving cryptocurrency information from a second user device associated with a second user in response to receiving an indication, from a first user, of a payment to be made to the second user. The illustrative embodiment generates a payment transaction with a cryptocurrency service provider via a network in response to receiving the cryptocurrency information. The illustrative embodiment receives a status response from the cryptocurrency service provider indicating a status of a transfer of an indicated amount of cryptocurrency from a cryptocurrency address of the first user to a cryptocurrency address of the second user completing. The illustrative embodiment provides an indication to the first user that the payment transaction has completed based on the status response.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a functional block diagram of a data processing system that comprises a cryptocurrency payment mechanism for automatically making payments using a cryptocurrency address embedded in a passive radio-frequency identification (RFID) device in accordance with an illustrative embodiment;

FIG. 4 depicts a function block diagram of a data processing system that comprises a passive radio-frequency identification (RFID) tag programming device for programming an RFID tag in accordance with an illustrative embodiment;

FIG. 5 depicts an exemplary flow diagram of the operation performed by a cryptocurrency payment mechanism for automatically making payments using a cryptocurrency address embedded in a passive radio-frequency identification (RFID) device in accordance with an illustrative embodiment; and

FIG. 6 depicts an exemplary flow diagram of a passive radio-frequency identification (RFID) tag programming device programming a passive RFID tag of a user in accordance with an illustrative embodiment.

### DETAILED DESCRIPTION

The illustrative embodiments provide mechanisms for automatically making payments using a cryptocurrency address embedded in a passive radio-frequency identification (RFID) device. As noted above, cryptocurrency is a medium of exchange like normal currencies such as the United States dollar (USD), but designed for the purpose of exchanging digital information through a process made possible by certain principles of cryptography. However, the process of receiving and paying using cryptocurrency needs to be more efficient. RFID tags are sometimes used for contactless payments but these RFID tags have several deficiencies. A first issue is the passive RFID tag needing to be coupled with a corresponding RFID reader, Which is not just a generic RFID reader. That is, usually it is the company that provides the passive RFID tag that also creates the corresponding RFID reader that is proprietary to the passive RFID tag. A second issue is, since RFID tags are usually used for making payments and encrypted account information associated with the passive RFID tag cannot be decrypted/read by any other RFID reader, RFID tags are not used for receiving payments by design.

The illustrative embodiments provide a mechanism that automates making payments using a cryptocurrency address embedded in a passive radio-frequency identification (RFID) device. In the embodiment, each user has a cryptocurrency address for digital payment and digital payment acceptance. The cryptocurrency address is embedded in a passive RFID tag, which is converted into a microchip (size of a grain) and, in one implementation, implanted inside the user, such as in the user's wrist. Since cryptocurrency address is unique to the user and embedded in the passive RFID tag owned by the user, when an event occurs where the user needs to make payment for an item or receive payment for an item, a user may use a generic RFID reader that identifies the passive RFID tag via radio waves to the passive RFID tag, reads the cryptocurrency address embedded in the passive RFID tag, and transfers the relevant cryptocurrency to/from the user who has RFID tag. Since the passive RFID tag is passive, the passive RFID tag does not include its own power and uses the power which receives from the probing radio waves of the generic RFID reader to operate.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

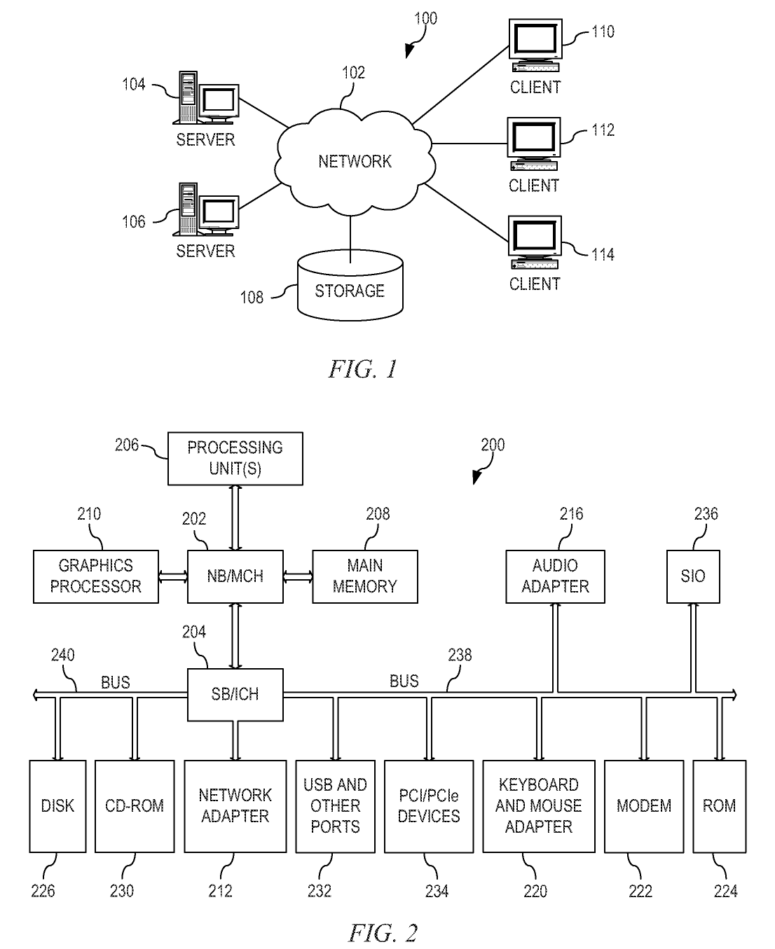

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement mechanisms that automatically make payments using a cryptocurrency address embedded in a passive radio-frequency identification (RFID) device. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automatically making payments using a cryptocurrency address embedded in a passive radio-frequency identification (RFID) device.

As noted above, the mechanisms of the illustrative embodiments utilize specifically configured computing devices, or data processing systems, to perform the operations for automatically making payments using a cryptocurrency address embedded in a passive radio-frequency identification (RFID) device. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect, to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206, Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the automatically making payments using a cryptocurrency address embedded in a passive radio-frequency identification (RFID) device.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

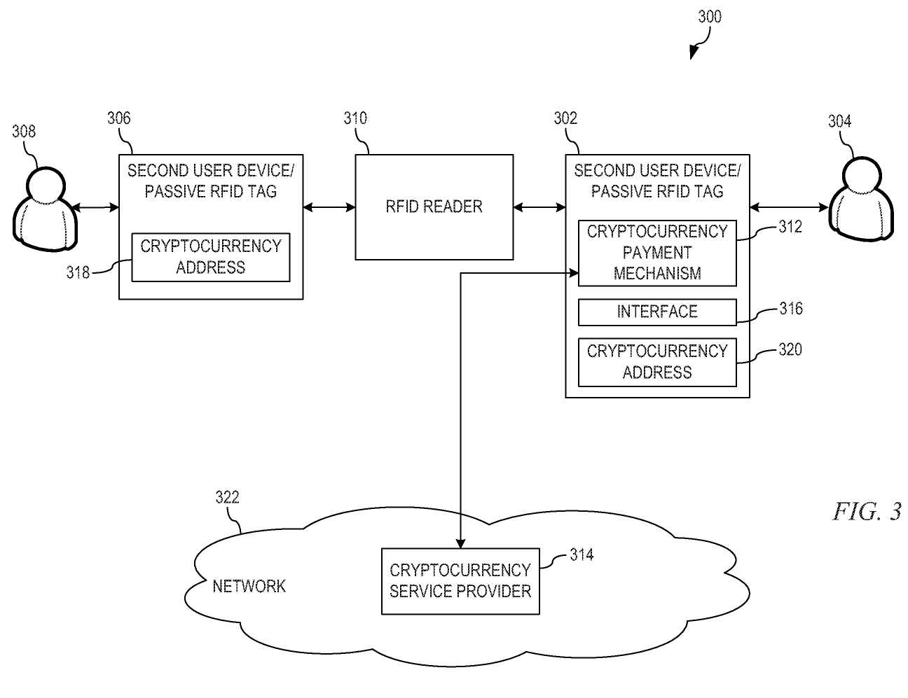

FIG. 3 depicts a functional block diagram of a data processing system that comprises a cryptocurrency payment mechanism for automatically making payments using a cryptocurrency address embedded in a passive radio-frequency identification (RFID) device in accordance with an illustrative embodiment. Data processing system 300 comprises first user device 302 associated with user 304, second user device 306 associated with user 308, and RFID reader 310. As user 304 indicates through interface 316 a selection, such as depressing a button, selecting an icon, or the like, on first user device 302, a payment is to be made to user 308, cryptocurrency payment mechanism 312 in first user device 302 receives the indication and connects to RFID reader 310. RFID reader 310 may be a device coupled directly to first user device 302, a device coupled to second user device 306, or a stand-alone device that is associated with either user 304 or user 308, such as a secondary smart device carried by user 304, a point of sale (POS) device associated with user 308, or the like.

Based on the connection from cryptocurrency payment mechanism 312, RFID reader 310 requests cryptocurrency information from second user device 306. In accordance with the illustrative embodiment, the second user device is a passive RFID tag. The passive RFID tag is a passive microchip (size of a grain) that is implanted inside user 308 and only operates when within a few centimeters of RFID reader 310. A passive RFID tag that has a passive microchip is a tag that does not include its own power but, instead, uses the power received from the probing radio waves of RFID reader 310 to operate. That is, in order to obtain the requested cryptocurrency information from second user device 306, RFID reader 310 sends radio waves to second user device 306 (i.e. the passive RFID tag). Using the radio waves, the RFID reader 310 reads one or more pieces of cryptocurrency information on the passive RFID tag. The passive RFID tag comprises cryptocurrency information, such as a cryptocurrency address 318 as well as a cryptocurrency type, RFID tag expiration information, a maximum cryptocurrency acceptance/usage value per transaction information, and the like. The crypto currency address is unique to user 308. The a cryptocurrency type indicates what type of cryptocurrency the tag is for, such as Bitcoin, Litecoin, Peercoin, Primecoin, Namecoin, Ripple, Quark, Dash, Blackcoin, or the like. The passive RFID tag expiration information indicates when the passive RFID tag will expire. The maximum cryptocurrency acceptance/usage value per transaction information indicates the maximum exchange of cryptocurrency during any transaction, whether buying or selling.

Upon obtaining the requested cryptocurrency information from second user device 306, RFID reader 310 sends the cryptocurrency information to cryptocurrency payment mechanism 312. Cryptocurrency payment mechanism 312 then generates a payment transaction with the appropriate cryptocurrency service provider 314 in network 322. The payment transaction includes transaction information such as a cryptocurrency address 318 of user 308, a cryptocurrency address 320 of user 304, and an amount of cryptocurrency to be exchanged as well as other information that may be relevant to the payment transaction. Cryptocurrency service provider 314 then makes the transfer from the cryptocurrency address 320 of user 304 to the cryptocurrency address 318 of user 308 of the indicated amount of cryptocurrency and sends a status response hack to cryptocurrency payment mechanism 312. Based on the status response, cryptocurrency payment mechanism 312 provides an indication to user 304 that the payment transaction has completed. The indication may be one or more of a displayed indication on a display of first user device 302, a playing of a sound indicating the payment transaction has completed on first user device 302, a vibration of the first user device 302, or the like.

Upon receiving the indication, user 304 may verbally inform user 308 of the payment transaction completion. Both user 304 and user 308 may then verify the payment transaction by access their own individual cryptocurrency wallet that verifies the amount of cryptocurrency in the cryptocurrency in the cryptocurrency wallet with cryptocurrency service provider 314.

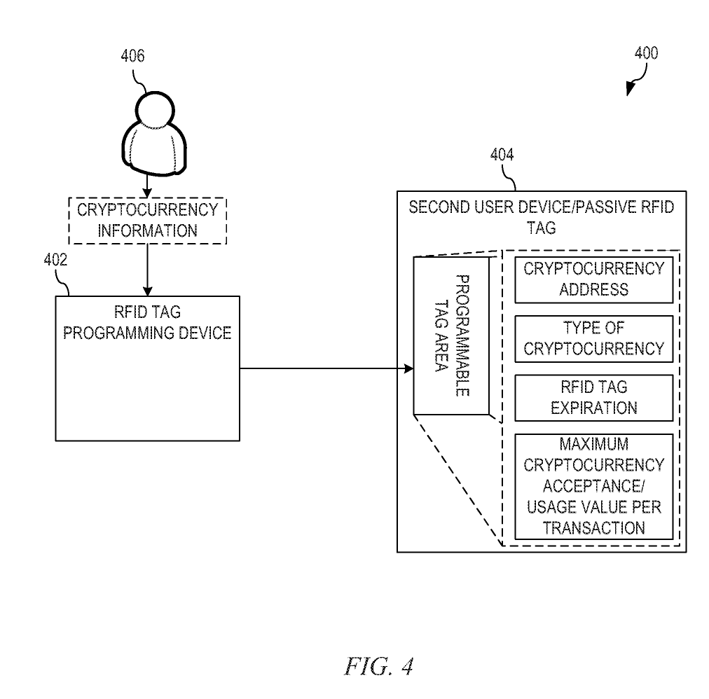

FIG. 4 depicts a function block diagram of a data processing system that comprises a passive radio-frequency identification (RFID) tag programming device for programming a passive RFID tag, such as second user device 302 of FIG. 3, in accordance with an illustrative embodiment. Data processing system 400 comprises RFID tag programming device 402 and passive RFID tag 404. User 406 provides cryptocurrency information to RFID tag programming device 402 such as a cryptocurrency address, a cryptocurrency type, RFID tag expiration information, a maximum cryptocurrency acceptance/usage value per transaction information, and the like. The crypto currency address is unique to user 406. The a cryptocurrency type indicates what type of cryptocurrency the tag is for, such as Bitcoin, Litecoin, Peercoin, Primecoin, Namecoin, Ripple, Quark, Dash, Blackcoin, or the like. The passive RFID tag expiration information indicates when the passive RFID tag will expire. The maximum cryptocurrency acceptance/usage value per transaction information indicates the maximum exchange of cryptocurrency during any transaction, whether buying or selling. Using this provided cryptocurrency information, RFID tag programming device 402 encodes programmable tag code area 408 of passive RFID tag 404. Programmable tag code area 408 may be an one-time programmable area or a updateable programmable area depending on the preferences of the user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory(RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

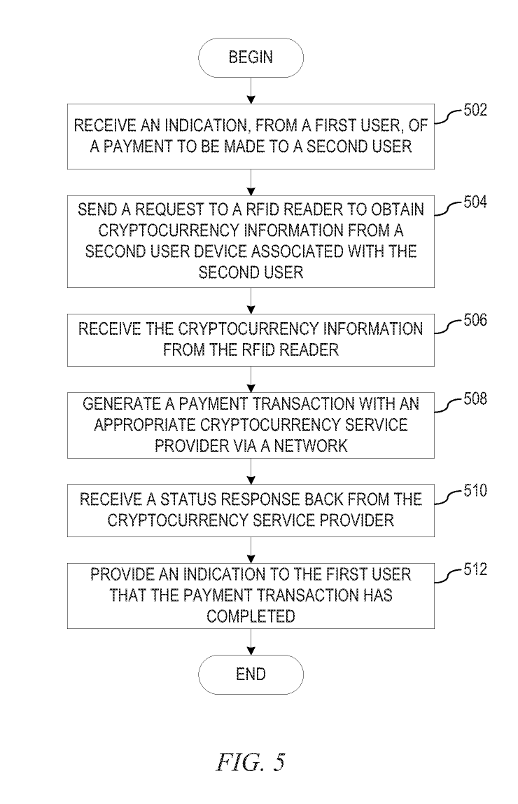

FIG. 5 depicts an exemplary flow diagram of the operation performed by a cryptocurrency payment mechanism for automatically making payments using a cryptocurrency address embedded in a passive radio-frequency identification (RFID) device in accordance with an illustrative embodiment. As the operation begins, the cryptocurrency payment mechanism, in a first user device, receives an indication, from a first user, of a payment to be made to a second user (step 502). The cryptocurrency payment mechanism sends a request to a RFID reader so that the RFID reader reads cryptocurrency information from a second user device associated with the second user (step 504). In accordance with the illustrative embodiment, the second user device is a passive RFID tag. The passive RFID tag is a passive microchip (size of a grain) that is implanted inside the second user and only operates when within a few centimeters of the RFID reader. A RFID passive tag that has a passive microchip is a tag that does not include its own power but, instead, uses the power received from the probing radio waves of the RFID reader to operate. That is, in order to obtain the requested cryptocurrency information from the second user device, the RFID reader sends radio waves to the second user device (i.e. the passive RFID tag). Using the radio waves, the RFID reader reads one or more pieces of cryptocurrency information on the passive RFID tag. The passive RFID tag comprises cryptocurrency information, such as a cryptocurrency address as well as a cryptocurrency type, RFID tag expiration information, a maximum cryptocurrency acceptance/usage value per transaction information, and the like. The crypto currency address is unique to the second user. The a cryptocurrency type indicates what type of cryptocurrency the tag is for, such as Bitcoin, Litecoin, Peercoin, Primecoin, Namecoin, Ripple, Quark, Dash, Blackcoin, or the like. The passive RFID tag expiration information indicates when the passive RFID tag will expire. The maximum cryptocurrency acceptance/usage value per transaction information indicates the maximum exchange of cryptocurrency during any transaction, whether buying or selling.

The cryptocurrency payment mechanism the receives the cryptocurrency information from the RFID reader (step 506) once the RFID reader obtains the requested cryptocurrency information from the second user device. The cryptocurrency payment mechanism then generates a payment transaction with the appropriate cryptocurrency service provider via a network (step 508). The payment transaction includes transaction information such as the cryptocurrency address of the second user, a cryptocurrency address of the first user, and an amount of cryptocurrency to be exchanged as well as other information that may be relevant to the payment transaction. Once the cryptocurrency service provider makes the transfer from the cryptocurrency address of the first user to the cryptocurrency address of the second user of the indicated amount of cryptocurrency, the cryptocurrency payment mechanism receives a status response back from the cryptocurrency service provider (step 510). Based on the status response, the cryptocurrency payment mechanism provides an indication to the first user that the payment transaction has completed (step 512), with the operation ending thereafter. The indication may be one or more of a displayed indication on a display of the first user device, a playing of a sound indicating the payment transaction has completed on the first user device, a vibration of the first user device, or the like.

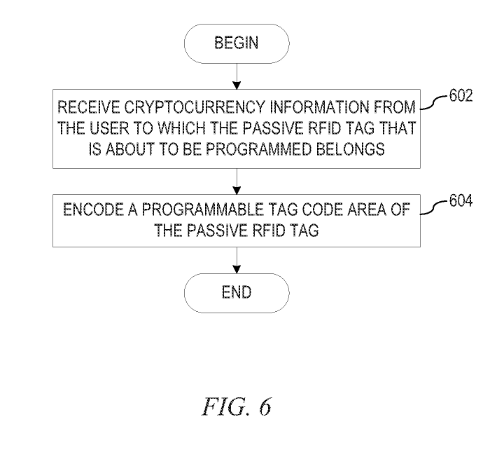

FIG. 6 depicts an exemplary flow diagram of a passive radio-frequency identification (RFID) tag programming device programming a passive RFID tag of a user in accordance with an illustrative embodiment. As the operation begins, the passive RFID tag programming device receives cryptocurrency information from the user to which the passive RFID tag that is about to be programmed belongs (step 602). The cryptocurrency information may include information such as a cryptocurrency address, a cryptocurrency type, RFID tag expiration information, a maximum cryptocurrency acceptance/usage value per transaction information, and the like. The crypto currency address is unique to the user. The a cryptocurrency type indicates what type of cryptocurrency the tag is for, such as Bitcoin, Litecoin, Peercoin, Primecoin, Namecoin, Ripple, Quark, Dash, Blackcoin, or the like. The passive RFID tag expiration information indicates when the passive RFID tag will expire. The maximum cryptocurrency acceptance/usage value per transaction information indicates the maximum exchange of cryptocurrency during any transaction, whether buying or selling. Using this provided cryptocurrency information, the passive RFID tag programming device encodes a programmable tag code area of the passive RFID tag (step 604), with the operation ending thereafter, The programmable tag code area may be an one-time programmable area or a updateable programmable area depending on the preferences of the user.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for automating payments using a cryptocurrency address embedded in a passive radio-frequency identification (RFID) device. Each user has a cryptocurrency address for digital payment and digital payment acceptance. The cryptocurrency address may be embedded in a passive RFID tag, which is converted into a microchip (size of a grain) and, in one implementation, implanted inside the user, such as in the user's wrist. Since cryptocurrency address is unique to the user and embedded in the passive RFID tag owned by the user, when an event occurs where the user needs to make payment for an item or receive payment for an item, a generic user may use a generic RFID reader that identifies the passive RFID tag via radio waves to the passive RFID tag, reads the cryptocurrency address embedded in the passive RFID tag, and transfers the relevant cryptocurrency to/from the user who has RFID tag. Since the passive RFID tag is passive, the passive RFID tag does not include its own power and uses the power which it receives from the probing radio waves of the generic RFID reader to operate.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications, Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory coupled to the processor, for automatically making payments using a cryptocurrency address embedded in a passive radio-frequency identification (RFID) device, the method comprising:
responsive to receiving an indication, from a first user, of a payment to be made to a second user, retrieving cryptocurrency information from a second user device associated with the second user;
responsive to receiving the cryptocurrency information, generating a payment transaction with a cryptocurrency service provider via a network;
receiving a status response from the cryptocurrency service provider indicating a status of a transfer of an indicated amount of cryptocurrency from a cryptocurrency address of the first user to a cryptocurrency address of the second user completing; and
based on the status response, providing an indication to the first user that the payment transaction has completed.

2. The method of claim 1, wherein the second user device is a passive RFID tag.

3. The method of claim 2, wherein the passive RFID tag is a passive microchip implanted inside the second user and only operates when within a few centimeters of a RFID reader.

4. The method of claim 2, wherein the passive RFID tag is a passive microchip that does not include its own power and uses power received from probing radio waves of an RFID reader to operate.

5. The method of claim 1, wherein the cryptocurrency information includes one or more of a cryptocurrency address, a cryptocurrency type, RFID tag expiration information, or a maximum cryptocurrency acceptance/usage value per transaction information.

6. The method of claim 1, wherein the indication is one or more of a displayed indication on a display of the first user device, a playing of a sound indicating the payment transaction has completed on the first user device, or a vibration of the first user device.

7. The method of claim 1, Wherein the second user device is a passive RFID tag that is programmed by a passive radio-frequency identification (RFID) tag programming device and wherein the passive RFID tag programming device programs the passive RFID tag using cryptocurrency information from a user to which the passive RFID tag that is about to be programmed belongs, wherein the cryptocurrency information comprises one or more of a cryptocurrency address of the user, a cryptocurrency type, RFID tag expiration information, or a maximum cryptocurrency acceptance/usage value per transaction information

8. The method of claim 7, wherein the passive RFID tag programming device encodes a programmable tag code area of the passive RFID tag and wherein the programmable tag code area is one of a one-time programmable area or a updateable programmable area.

9. A computer program product comprising a computer readable storage medium having a computer readable program stored therein, wherein the computer readable program, when executed on a computing device, causes the computing device to:
responsive to receiving an indication, from a first user, of a payment to be made to a second user, retrieve cryptocurrency information from a second user device associated with the second user;
responsive to receiving the cryptocurrency information, generate a payment transaction with a cryptocurrency service provider via a network;
receive a status response from the cryptocurrency service provider indicating a status of a transfer of an indicated amount of cryptocurrency from a cryptocurrency address of the first user to a cryptocurrency address of the second user completing; and
based on the status response, provide an indication to the first user that the payment transaction has completed.

10. The computer program product of claim 9, wherein the second user device is a passive RFID tag.

11. The computer program product of claim 10, wherein the passive RFID tag is a passive microchip implanted inside the second user and only operates when within a few centimeters of a RFID reader.

12. The computer program product of claim 10, wherein the passive RFID tag is a passive microchip that does not include its own power and uses power received from probing radio waves of an RFID reader to operate.

13. The computer program product of claim 9, wherein the cryptocurrency information includes one or more of a cryptocurrency address, a cryptocurrency type, RFID tag expiration information, or a maximum cryptocurrency acceptance/usage value per transaction information.

14. The computer program product of claim 9, wherein the indication is one or more of a displayed indication on a display of the first user device, a playing of a sound indicating the payment transaction has completed on the first user device, or a vibration of the first user device.

15. An apparatus comprising:
a processor; and
a memory coupled to the processor, wherein the memory comprises instructions which, when executed by the processor, cause the processor to:
responsive to receiving an indication, from a first user, of a payment to be made to a second user, retrieve cryptocurrency information from a second user device associated with the second user;
responsive to receiving the cryptocurrency information, generate a payment transaction with a cryptocurrency service provider via a network;
receive a status response from the cryptocurrency service provider indicating a status of a transfer of an indicated amount of cryptocurrency from a cryptocurrency address of the first user to a cryptocurrency address of the second user completing; and
based on the status response, provide an indication to the first user that the payment transaction has completed.

16. The apparatus of claim 15, wherein the second user device is a passive RFID tag.

17. The apparatus of claim 16, wherein the passive RFID tag is a passive microchip implanted inside the second user and only operates when within a few centimeters of a RFID reader.

18. The apparatus of claim 16, wherein the passive RFID tag is a passive microchip that does not include its own power and uses power received from probing radio waves of an RFID reader to operate.

19. The apparatus of claim 15, wherein the cryptocurrency information includes one or more of a cryptocurrency address, a cryptocurrency type, RFID tag expiration information, or a maximum cryptocurrency acceptance/usage value per transaction information.

20. The apparatus of claim 15, wherein the indication is one or more of a displayed indication on a display of the first user device, a playing of a sound indicating the payment transaction has completed on the first user device, or a vibration of the first user device.
